(19) United States
(12) Patent Application Publication
(10) Pub. No.: US 2014/0372844 A1
(43) Pub. Date: Dec. 18, 2014

(54) INTERFACE FOR CAPTURING A DIGITAL IMAGE WITH REAL-TIME TEXT

(71) Applicant: Amar Zumkhawala, Arlington, VA (US)

(72) Inventor: Amar Zumkhawala, Arlington, VA (US)

(21) Appl. No.: 14/459,395

(22) Filed: Aug. 14, 2014

(51) Int. Cl. G06F 17/21; G06F 17/24

(52) U.S. Cl. CPC G06F 17/211; G06F 17/24
USPC 715/204

(57) ABSTRACT

The interface provides a means of capturing a composite digital image on a mobile computer, wherein a captured image is a composite of digital camera image data and text. The interface presents a real-time preview wherein the geometry, quality, and resolution of the preview are allowed to differ from the geometry, quality, and resolution of a captured image. The interface responds to computer characteristics' changes, data changes over time, and interface interactions by updating the preview in real-time, wherein text updates are introduced in an animated manner. The interface permits customization of the text's presentation, including position, scale, font, and style, where style includes color and other common attributes of text that affect visual presentation. The interface contextually adds sections based on the type of textual information composited.

### BACKGROUND OF INVENTION

A. Field of Invention

The present invention generally relates to digital image capturing, and more particularly, to interfaces on mobile computers for capturing a digital image composited from digital camera image data and textual data.

B. Description of Related Art

A real-time What-You-See-Is-What-You-Get (WYSIWYG) interface contrasts to a post-edit interface. A real-time WYSIWYG interface displays a representation of the final image prior to capture. Then, upon image capture, no further edits are necessary. In a post-edit interface, first an image is captured, and then in a second step, subsequently edited. A type of edit, for example, would be adorning text onto the image.

For scenarios demanding user simplicity or marked by time pressure, a reduction in required steps provides a valuable efficiency.

Mobile computers typically offer alternate user inputs and lack a traditional computer mouse or tablet that PCs offer. Mobile computers are characteristically gesture driven; a user controls the computer through gestures such as swipes and taps. Notably, PCs peripherals offer control and usability that facilitate a post-edit approach whereas mobile computers inherently do not. Further, the smaller sized user input devices of mobile computers, compared to PCs, challenge text customization interfaces. Therefore, it is more cumbersome and time consuming to post-edit an image through gestures.

Animations augment interfaces because they facilitate user comprehension of changes that occur. This is because of how the human eye perceives animations such as motion, hue, or contrast changes as visual information. Communicating change as it occurs is the core benefit of a real-time system, especially one that automatically updates textual representations of data on behalf of the user. In contrast, non-real time approaches to composite image generation do not continually update. Thus, real-time systems benefit from animation, whereas non-real time systems do not actively communicate responses to change and thus do not benefit from animation.

Therefore, there is a need on mobile computers to have an animated, real-time interface for capturing a digital image composited with text.

### SUMMARY OF THE INVENTION

The interface, operating on a mobile computer, provides a means of capturing a composite digital image. A captured image is a composite of digital camera image data and text. Image capture can be achieved with an efficient, minimal set of user interactions, inputted via hand gestures.

The interface presents a real-time preview prior to capture. The preview is comprised of continuously updated textual content and live image data from a digital camera. The geometry, quality, and resolution of the preview can differ from the geometry, quality, and resolution of a captured image.

The interface responds to computer characteristics' changes, data changes over time, and interactions by updating the preview in real-time, wherein text updates are introduced in an animated manner. Additionally, the interface provides customization abilities of the text's presentation, including position, scale, font, and style, where style includes color and other common attributes of text that affect visual presentation.

Further, the interface contextually adds sections based on the type of textual information composited.

### BRIEF DESCRIPTION OF DRAWINGS

The present invention is described in detail below with reference to the attached drawings figures, wherein:

FIG. 1 is a block diagram overview of an interface in accordance with an embodiment of the invention;

FIGS. 2A to 2C are screen shots of an interface in accordance with an embodiment of the invention;

FIG. 3 is a block diagram illustrating a computerized environment in which embodiments of the invention may be implemented;

FIGS. 4A and 4B are flow diagrams illustrating a method for implementing the interface in accordance with an embodiment; and

FIGS. 5A and 5B are illustrations of the user interface and captured image in accordance with an embodiment.

### DETAILED DESCRIPTION OF THE INVENTION

The present invention is an interface to an image capturing system with a real-time preview, wherein a captured image is a composite of digital camera image data and textual data. Both textual data and camera image data are continually updated within the preview as the interface operates and responds to events. Updates to textual representations of data are presented in an animated manner.

The following description refers to the accompanying drawings. The detailed description of the drawings does not limit the invention.

### I. Overview of the Interface

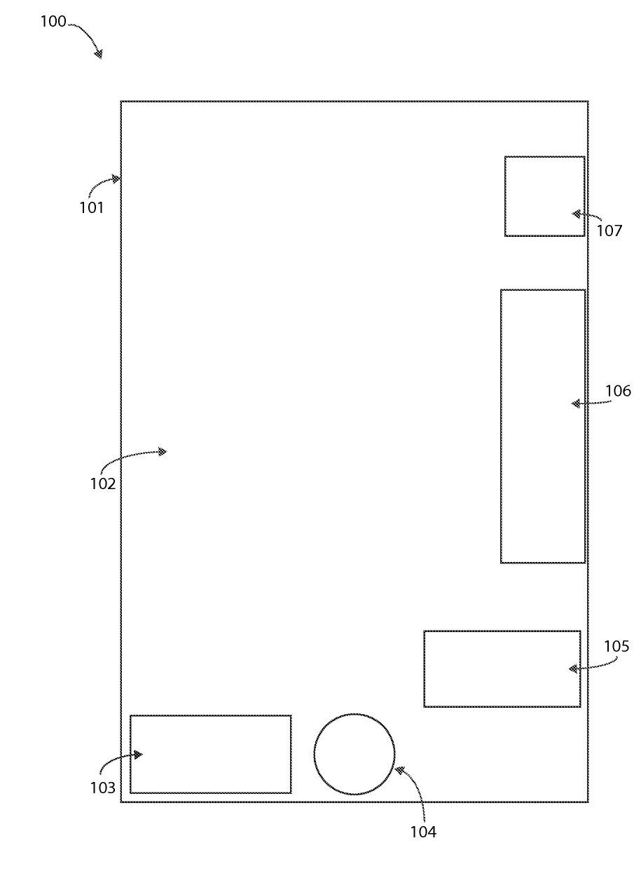

FIG. 1 is an overview of the components of the interface 100 in accordance with an embodiment of the invention. The interface presents itself within a frame 101, where the frame 101 is shaped within geometry that is independent of the captured image. Thus, this geometry may or may not be representative of the captured image and is very dependent on the mobile computer's capabilities and display. The interface 100 displays camera image data in a view 102 within a dimensional ratio that is independent of a captured image's dimensions. The camera image data view 102 is continually updated as new data becomes available.

Textual representation of data 105 is positioned by the interface within the camera data view 102. The interface's presentation is not necessarily a pixel-by-pixel sizing of the text as stored in a captured image, as the interface 100 permits the captured image to be of a different resolution and quality than presented by a mobile computer's display.

The interface offers customization of the text 105 through a panel 106. A user may gesture with a tap on one or more buttons within the panel 106 to direct the interface to customize or initiate customization of the text 105.

Text 105 may have an associated interface 103, which permits control of the underlying data that the text represents. The interface displays control elements contextually based on the type of data represented by the text. The contextual interface provides control of the underlying data represented by the text.

The interface provides a means 104 to initiate image capture. As an example, a user may gesture with a tap on a button 104 to direct the interface to capture an image. To signal completion of an initiated capture request, the interface presents a portion of the captured image as a thumbnail 107.

The invention does not require all interface sections to be visually present at all times. More particularly, the number, size, and layout of the sections could be changed.

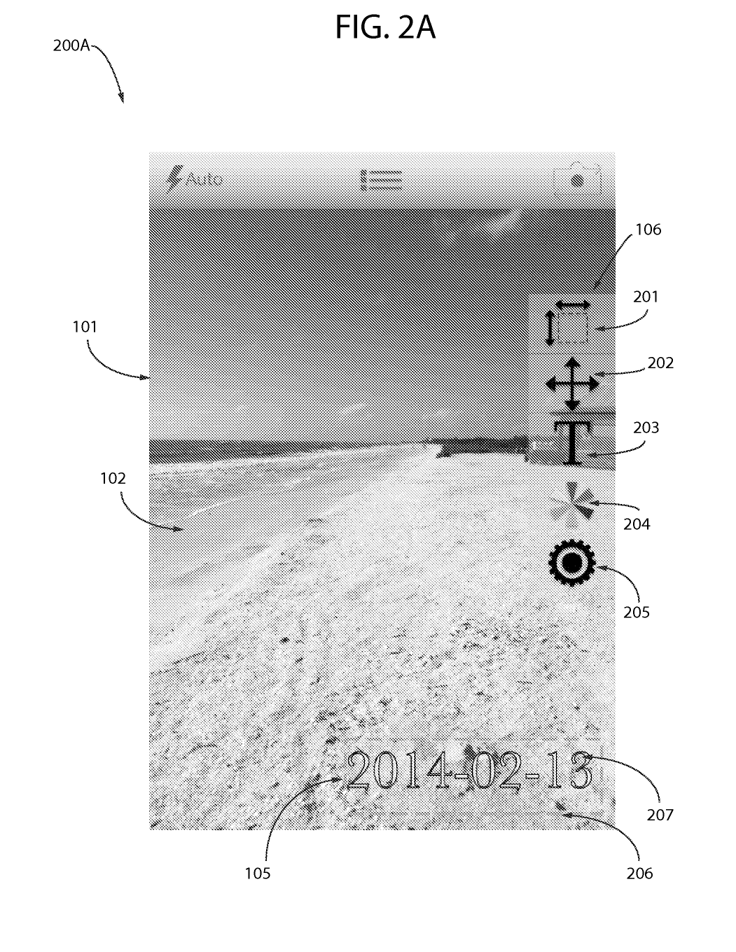

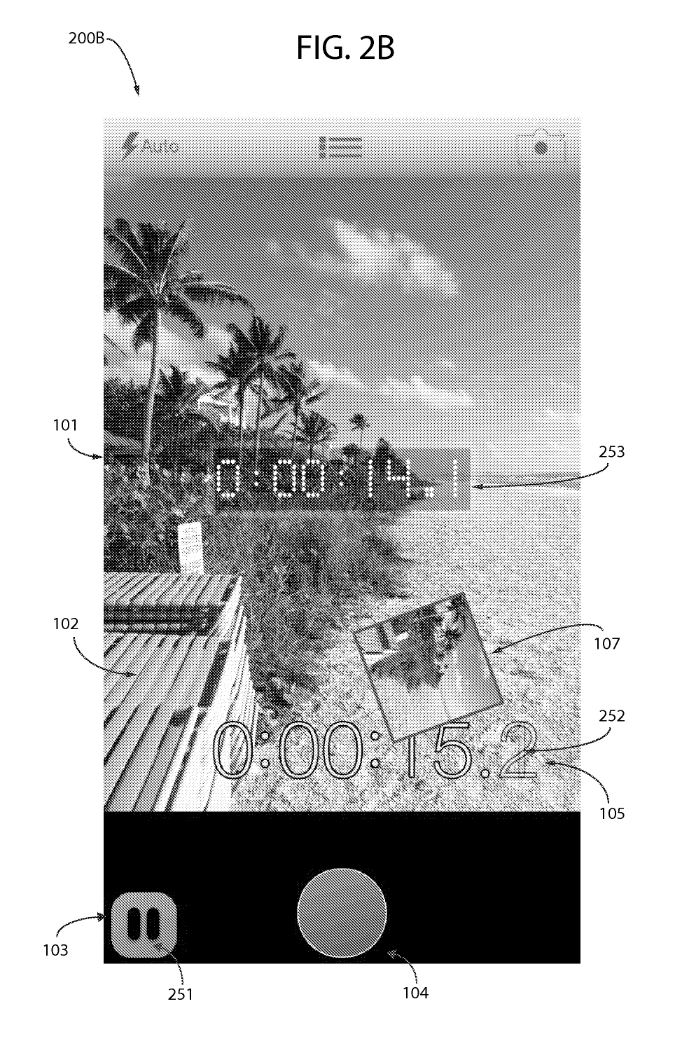

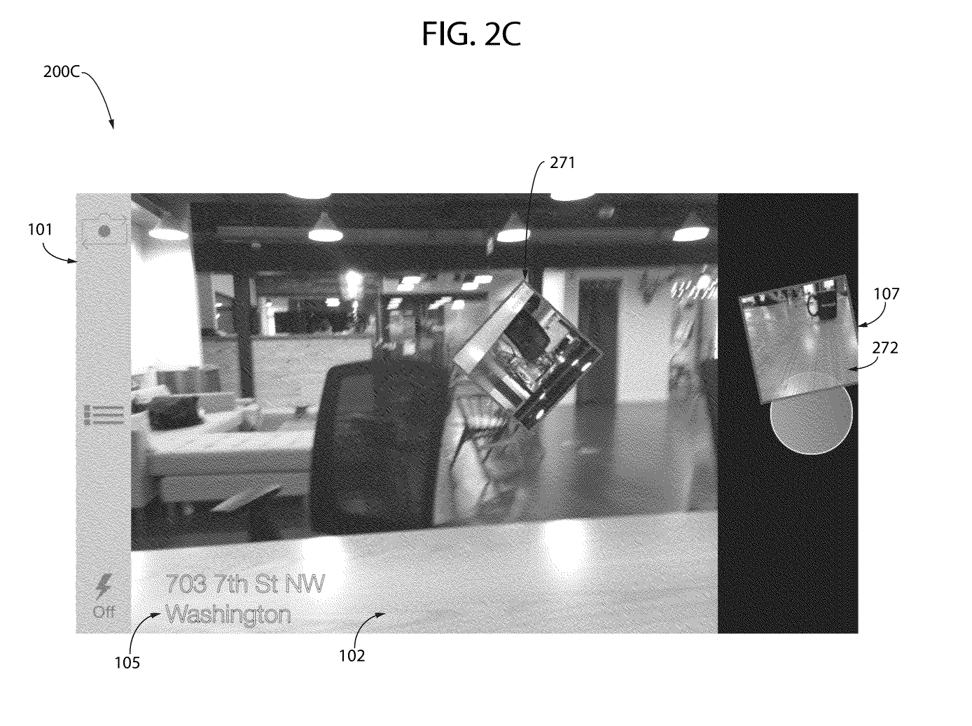

FIG. 2A contains screen shot 200A, where a panel 106 presents several options to customizing the presentation of text 105. Customization includes the scale of the text in proportion to the image data 201, the position of the text within a captured image 202, customization of the font 203, the style attributes of the text that affect the text presentation 204, and formatting of the textual representation of the data 205.

The formatting interface 205 contextually offers different formats of the text 105. The context is the type of data underlying the text. As an example the current calendar date underlies the text “2014-02-13” 207, thus the formatting interface 205 will offer calendar date format options. The invention is not limited to offering calendar date formatting options, as the underlying data is not limited to being a calendar date.

The interface visually indicates when gestures direct customization on the text 105 by presenting a visual indication 206, a dotted border with animated hues. Note this visual indication is present in the interface and never present in a captured image.

The interface may also operate without showing the visual indication. For example, the interface could temporally hide the panel 106 and prevent customization, in which case the visual indication 206 would not be present.

FIG. 2B is a screen shot 200B of an interface in accordance with an embodiment of the invention. In the screen shot, a contextual interface 103 offers control of the text 105. In this example, a stopwatch is presented along with a contextual interface. Because the stopwatch is running, the interface offers a pause button 251. A textual representation of the elapsed time 252 is presented by the interface. The elapsed time is updated in real-time along with the presentation of camera image data 102. The embodiment is not limited to presenting contextual interfaces for a stopwatch, as a stopwatch is only used as an example.

The interface signals completion of a captured image with a thumbnail 107 and temporarily presents the elapsed time 253 associated with the image 107. The temporary presentation is added onto the interface in an animated manner and removed after a short duration.

FIG. 2C is a screen shot 200C of an interface in accordance with an embodiment of the invention. The interface has finished responding to a request to capture an image and has completed the capture. Here, in an animated, conjunctional manner, a new thumbnail 271 representing the most recent captured image 107 is moved into the position of the prior thumbnail 272, being moved off the interface.

The interface animates the addition of the thumbnail 107 to the interface. The position of the thumbnail 107 begins in the center of the frame 101 and then moves in an animated manner towards a different position within frame 101, where it ceases moving and the animation completes. If a subsequent image is captured, a new thumbnail is placed in the center of the frame 101 representing the subsequent image. Then, in an animated, conjunctional manner, the prior thumbnail 272 is moved off the interface while the new thumbnail 271 is moved towards the position of the prior thumbnail 272.

The interface may subsequently move the thumbnail 107 in response to events. For example, the interface may respond to changes in the device's orientation or a request to initiate customization by repositioning or temporarily hiding the thumbnail. The thumbnail may or may not cover a part of the camera view 102 or textual tag 105. The user can gesture to remove the thumbnail after it is presented. The thumbnail is never a part of any future captured image.

### II. Overview of Computing Environment

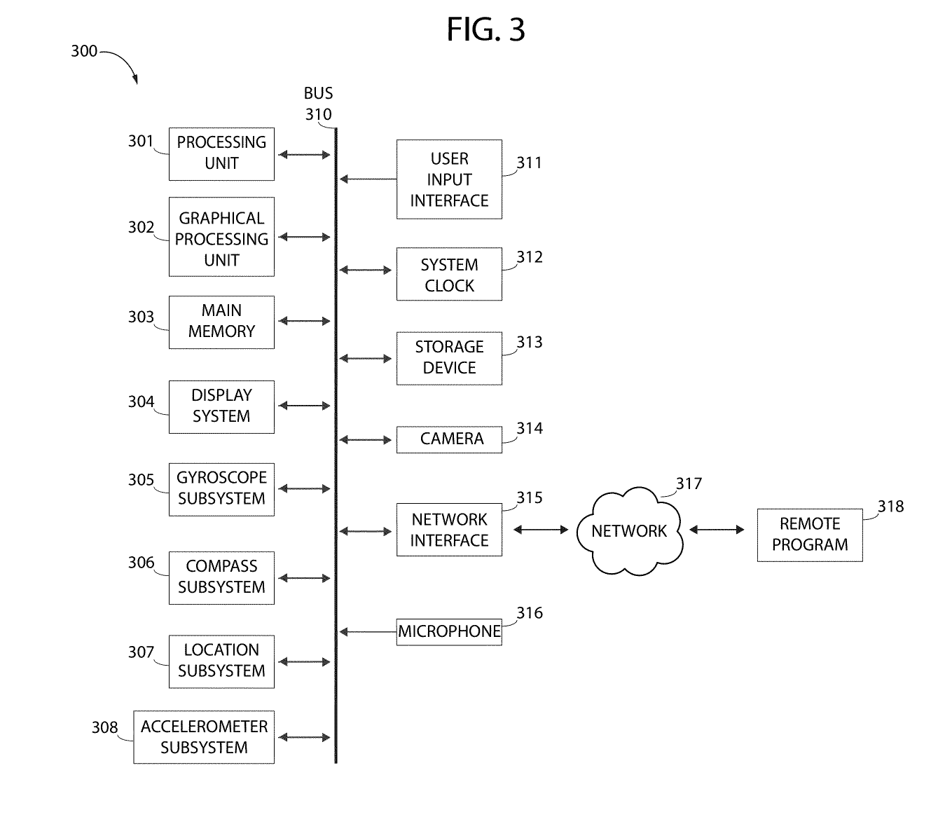

FIG. 3 Illustrates a suitable mobile computing environment 300 for the invention to operate within. The environment provides a processing unit 301 and a graphical processing unit 302. Both processors interact with a camera 314 over a bus 310. The computer has main memory 303 where software code and data is stored during execution as well as a storage device 313 where data can be stored when the mobile computer is powered off. The user input interface 311 permits a user through gestures to interact with the computing environment. The computer environment visualizes information on the display system 304. A microphone 316 may optionally be available to sense sound.

The computing environment provides a gyroscope subsystem 305 and accelerometer system 308. These subsystems continually sense characteristics such as physical orientation and physical movement. Similarly, the environment provides both a compass subsystem 306 and a location subsystem 307. The compass 306 detects direction in a frame of reference to Earth. The location subsystem 307 determines location, where location is delivered within a geographic coordinate system. All subsystems communicate with the processing unit 301 and main memory 302 over the bus 310.

The computer environment has a network interface 315 which permits communicates through a computer network 317. Communication with a remote program 316 is not required; however, a remote program may provide data for use by a software program executing in the computing environment.

A system clock 312 tracks the amount of time passed since an epoch. Those skilled in the art will understand the system clock is programmable and can operate in different time resolutions.

### III. Overview of Implementation

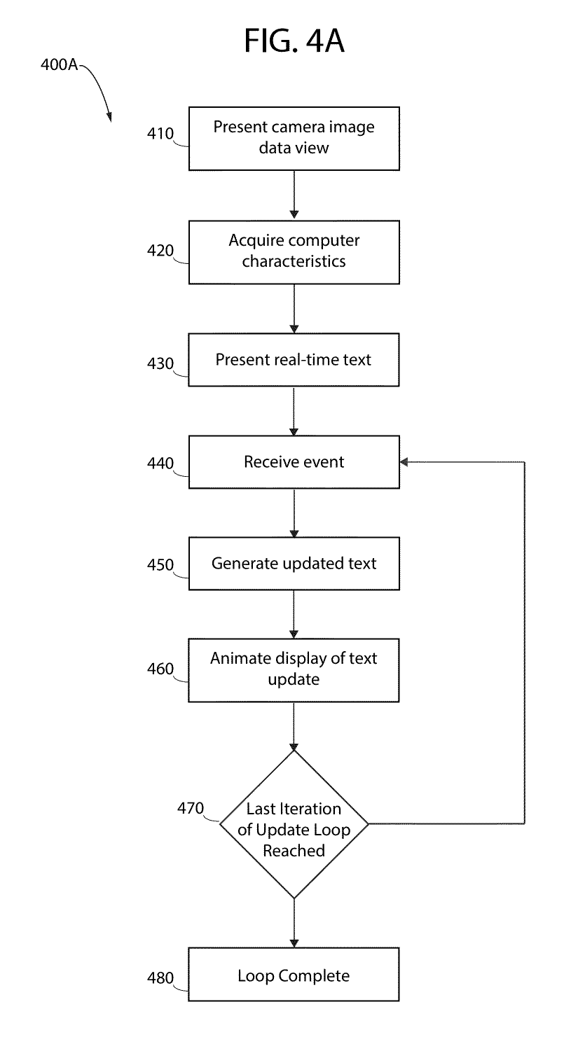

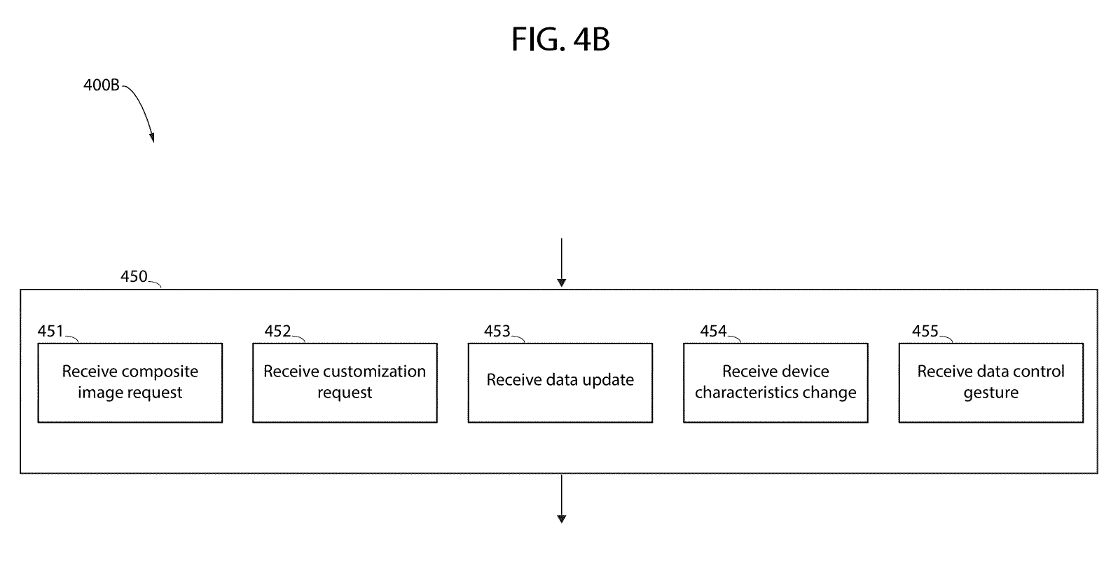

FIGS. 4A and 4B are flow charts illustrating a method for implementing interface 100 in accordance with an embodiment. The process 400A details a pipeline that defines the updating of the real-time text. The process begins with the interface 410 presenting the camera image data within the camera view 102, taking into consideration attributes of the computer display system 310. Once presented, the camera view continues to update on its own accord. Data describing the computer's characteristics is acquired 420 from the subsystems such as gyroscope 305, accelerometer 308, compass 306, and location 307. The real-time text is then presented 430. An event is received 440, where after a text update is generated 450 and subsequently presented with animation 460. The process then decides to loop 470; if it has reached the last update iteration, the loop completes 480. Otherwise, the loop continues to process events 440.

The interface responds to a set of events detailed in sub-process 400B. The interface may receive one of the following 450: a request to generate a captured image 451, a request to customize the text 452, data updates 453 in relation to the data sources represented by text 105, computing environment characteristic changes 454 from subsystems such as the gyroscope 305 or accelerometer 308, or a data control gesture 455 inputted through the contextual interface 103.

The process can receive a data control gesture 455 through the contextual interface 103. The process animates updates of the textual representation resulting from control though the contextual interface 103, contextually choosing an animation that conveys the type of data change. For example, with a new value of a number, movement is chosen to animate the display of text update 460.

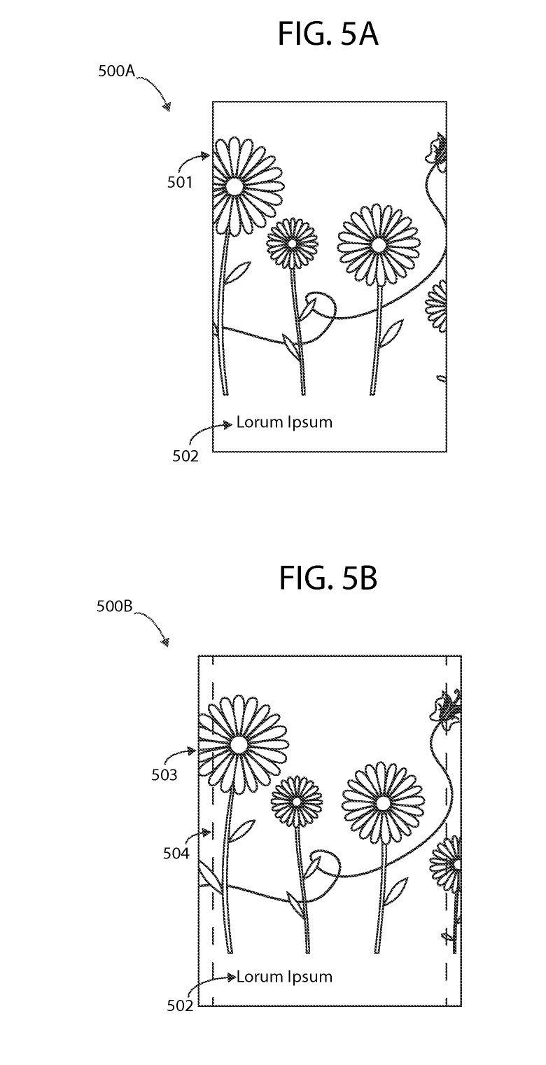

FIGS. 5A and 5B are illustrations that exemplify how the interface will make adjustments when the preview 500A and captured image 500B are of different dimensions. In responding to a request to capture an image 451, the interface will capture an image that may differ in dimensions and resolution from the camera view 102. For example, here the preview is in a rectangular frame 501 with a 4:3 ratio, in contrast to the captured image, which is in a rectangular frame 503 with a 2:3 ratio.

Some mobile device displays are of ratios or geometries different than the captured image, therein the interface may choose to not display within the camera view 102 all available camera image data. Here, data is clipped in the preview 500A whereas it is present in the captured image 500B. The exemplary dotted border 504 illustrates the clipping present in the preview 500A as it relates to the unclipped captured image 500B.

When camera data is clipped in the preview 500A and unclipped in the captured image 500B, the distance from the edge of the unclipped image frame 503 to the text 502 will differ from the distance to the edge of the preview frame 501, thus giving the text 502 a different coordinate plane position within the captured image than the preview. Clipping is not limited to a preview in rectangular display, as the interface may clip the preview on a circular display, as would be apparent to those skilled in the art.

When the captured image 503 is of a different resolution than the preview 501, the text 502 is scaled up or down in quality and size to maintain proportion with respect to the frames.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

What is claimed is:

1. An interface for generating a digital image, comprising:
a preview presenting real-time text and digital camera image data; and
a means of capturing an image for storage;
wherein
text updates are displayed in an animated manner in response to events.

2. The interface of claim 1, further comprising a means of customizing the position of text

3. The interface of claim 1, further comprising a means of customizing the text's scale in relation to the image's scale

4. The interface of claim 1, further comprising a means of customizing the text's typographical attributes and colors

5. The interface of claim 1, further comprising a means of customizing the text's formatting in relation to a data type

6. The interface of claim 1, further comprising more than one element of text updated in real time

7. The interface of claim 1, further comprising a means of contextual control of the mechanisms affecting the data underlying the text

8. The interface of claim 1, further comprising an animated presentation signaling completion of a captured image

9. The interface of claim 1, further comprising a dotted border wherein the border's hues continually shift to indicate text customization

10. The interface of claim 1, further comprising an interface for a stopwatch

11. The interface of claim 1, further comprising adjustments in captured images for differences between computer display geometry and camera image data geometry

12. A method comprising:
continually updating a real-time text, wherein the text is updated in an animated manner in response to:
receiving a customization request;
receiving an update to the data underlying the textual representation;
receiving changes in the computing environment;
receiving changes stemming from operation of a contextual data control interface

13. The method of claim 12, further comprising receiving a request to generate a composite image

14. The method of claim 12, further comprising receiving a request to continually, at a pre-determined interval, generate captured images
